(19) United States
(12) Patent Application Publication
(10) Pub. No.: US 2017/0172132 A1
(43) Pub. Date: Jun. 22, 2017

(54) Lure Protector

(71) Applicant: CAL COAST FISHING, Carpinteria, CA (US)

(72) Inventor: David ROMANUS, Goleta, CA (US)

(73) Assignee: Cal Coast Fishing, Carpinteria, CA (US)

(21) Appl. No.: 15/127,734

(22) PCT Filed: Mar. 25, 2015
(86) PCT No.: PCT/US2015/022510

§ 371 Date: Sep. 20, 2016

Related U.S. Application Data
(60) Provisional application No. 61/971,497, filed on Mar. 27, 2014.

(51) Int. Cl. A01K 97/06; B65D 75/26; B65D 75/06

(52) U.S. Cl. CPC A01K 97/06; B65D 75/06; B65D 75/26

(57) ABSTRACT

A lure protector for a fishing lure attached to a fishing pole with a fishing line includes a pouch, a reinforcing member coupled to the pouch, and a clip coupled to the pouch. The pouch defines a top opening through which the fishing lure may pass, and an interior sized to receive the fishing lure. The reinforcing member includes an end portion to which the fishing line may be coupled. The clip is configured to couple the lure protector to the fishing pole.

### CROSS REFERENCES TO RELATED PATENT APPLICATIONS

This application claims priority from U.S. Provisional Application No. 61/971,497, filed Mar. 27, 2014, the contents of which are incorporated herein by reference in the entirety.

### BACKGROUND

When individuals are fishing and using various forms of lures, there is a danger from the sharp and penetrating types of hooks used in all of these devices. When a user of the lure needs to store the equipment, it is common practice to hook the lure on the rod's hook keeper or onto the reel and snug the line. This leaves the dangerous hooks exposed and capable of piercing the flesh of the user or bystanders. This also leaves the rods and lures open and easily tangled.

### SUMMARY OF THE INVENTION

One embodiment relates to a lure protector for use with a fishing lure attached to a fishing pole with a fishing line. The lure protector includes a pouch, a reinforcing member coupled to the pouch, and a clip coupled to the pouch. The pouch defines a top opening through which the fishing lure may pass, and an interior sized to receive the fishing lure. The reinforcing member includes an end portion to which the fishing line may be coupled. The clip is configured to couple the lure protector to the fishing pole.

Another embodiment relates to a lure protector kit for use with a fishing lure attached to a fishing pole with a fishing line. The kit includes a lure protector and a clip. The lure protector includes a pouch and a reinforcing member coupled to the pouch. The pouch defines a top opening through which the fishing lure may pass, and an interior sized to receive the fishing lure. The reinforcing member includes an end portion to which the fishing line may be coupled. The clip is coupled to the lure protector and is configured to couple the lure protector to the fishing pole.

Still another embodiment relates to a lure protector for use with a fishing lure attached to a fishing pole with a fishing line. The lure protector includes a pouch defining a top opening through which the fishing lure may be pass, and a substantially smooth interior sized to receive the fishing lure. The lure protector further includes a stiffening member, a reinforcing spine, a hook, and a clip. The stiffening member is coupled to the pouch proximate to the top opening. The reinforcing spine is coupled to the pouch and extends along the pouch from the top opening. The reinforcing spine includes a catch to which the fishing line may be coupled. The hook extends from the reinforcing spine opposite of the catch, positioned as to engage a portion of the fishing pole. The clip is coupled to the pouch. The clip is configured to couple the lure protector to the fishing pole.

Yet another embodiment relates to a fishing pole system including a fishing pole, a fishing lure operatively connected thereto, a fishing line operatively connected to the fishing lure and the fishing pole, and a lure protector. The lure protector includes a pouch, a reinforcing member coupled to the pouch, and a clip coupled to the pouch. The pouch defines a top opening through which the fishing lure may pass, and an interior sized to receive the fishing lure. The reinforcing member includes an end portion to which the fishing line may be coupled. The clip removably couples the lure protector to the fishing pole.

It is to be understood that both the foregoing general description and the following detailed description are exemplary and explanatory only, and are not restrictive of the invention as claimed.

### BRIEF DESCRIPTION OF THE DRAWINGS

Various features, aspects, and advantages of the various embodiments described herein will become apparent from the following description, appended claims, and the accompanying exemplary embodiments shown in the drawings, which are briefly described below.

FIG. 1 is a front perspective view of a lure protector, according to an exemplary embodiment.

FIG. 2 is a rear perspective view of the lure protector of FIG. 1.

FIG. 3 is a perspective view of the lure protector of FIG. 1 coupled to a fishing pole with a fishing lure received in the lure protector.

FIG. 4 is a cross-section view of the lure protector and fishing pole of FIG. 3, taken along line 4-4 thereof.

FIG. 5 is a perspective view of a reinforcing spine and clip for the lure protector of FIG. 1.

### DETAILED DESCRIPTION

The word “lure” as used herein to describe all forms of artificial (e.g., non-living) fishing bait including, but not limited to lures, hooks, treble hooks, bait, flies, jigs, rigs, plugs, etc. or any combination thereof.

The lure protector described herein provides a mechanism for a user to quickly and simply receive a fishing lure and couple the fishing lure to a fishing rod in such a way that the lure is protected and any sharp portions of the lure, such as hooks, are contained within the lure protector. This arrangement thereby protects the user or other surrounding people or animals from injury by the fishing lure. The lure protector attaches to the fishing pole such that the fishing lure and the fishing pole can be stored without the fishing lure and the fishing line becoming tangled. Further, the lure protector also helps to protect the lure against environmental conditions.

The lure protector includes a flexible pouch that is configured to receive the lure, a reinforcing member to which the lure is coupled, and a connector that is coupled to the rib and the pouch and configured to removably couple the lure protector to a fishing pole. The pouch may be a transparent or substantially transparent plastic material so that a user may more easily choose a desired pole/lure setup. The pouch includes a normally closed upper end that may be opened (by, for example, a squeezing action) by a user to allow the fishing lure to be inserted into the pouch or removed from the pouch.

The lure protector may be operated by the user with one hand in such a way that the user's hands and body do not need to touch the fishing lure. With the lure received in the lure protector and coupled to the fishing pole, the rod may be stored with the attached lure held securely in place. The lure may be easily removed from the lure protector by the user operating the lure protector with one hand. The user does not need to touch the lure, or place their hand in the way of the lure, in order to remove the lure from the lure protector.

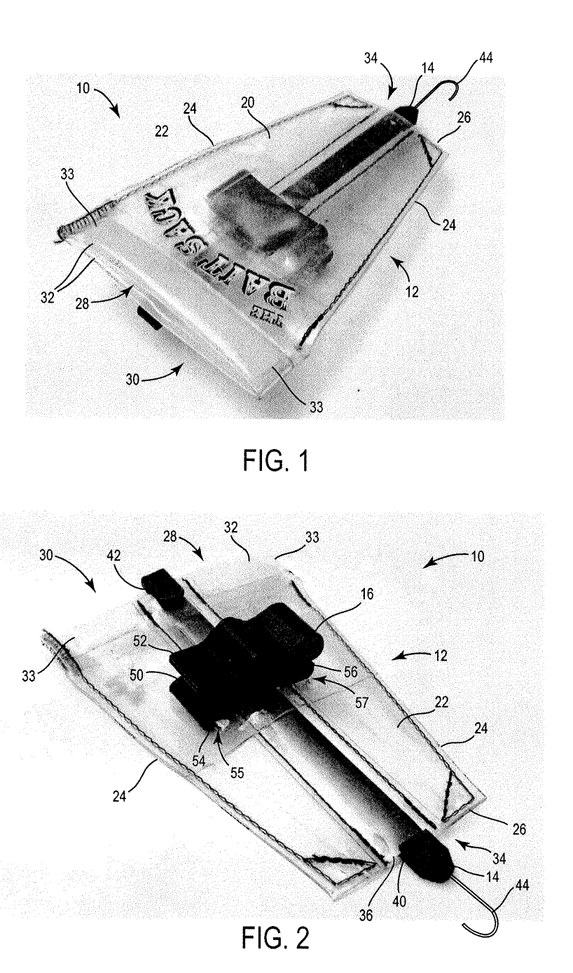

Referring to FIGS. 1-4, a lure protector 10 is shown according to an exemplary embodiment. The lure protector 10 includes a main body in the form of a pouch 12 (e.g., a sleeve, shroud, sack, envelope, pocket, etc.), a reinforcing spine 14 coupled to the pouch 12, and a clip 16 coupled to the spine 14 and the pouch 12. The lure protector 10 is generally formed from materials that are compatible with use in both fresh water and salt water environments.

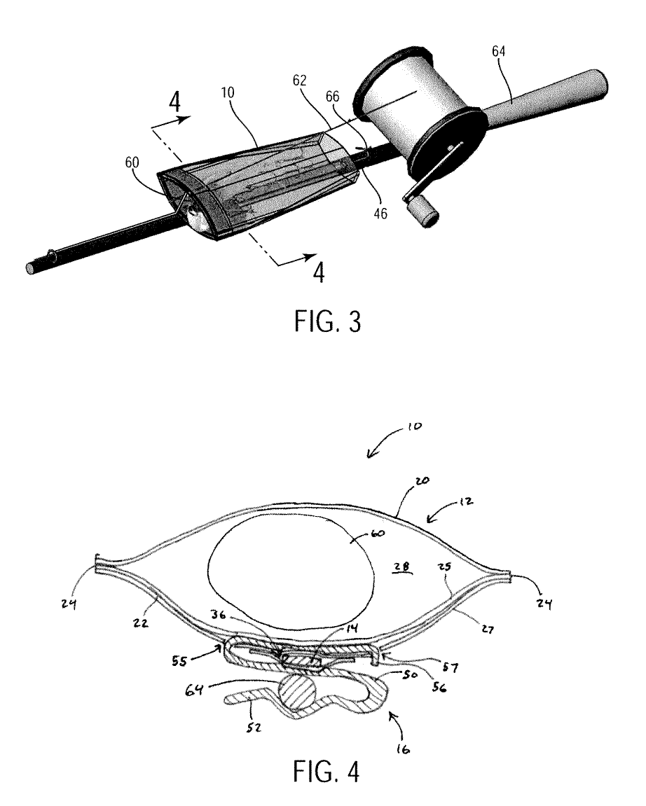

The pouch 12 provides an enclosure for a fishing lure 60 (see FIG. 3). The pouch 12 protects the user from the hooks or other sharp or protruding portions of the lure 60 and allows a fishing pole 64 with the lure 60 to be stored safely and without tangling the hooks. According to an exemplary embodiment, the pouch 12 is a relatively flexible body that is formed from a first or front panel 20 and a second or back panel 22. The front panel 20 and the back panel 22 are joined together alongside edges 24 thereof and are at least partially joined together along a bottom edge 26 to form an interior 28. In other embodiments, the pouch 12 may be formed with a bottom panel that is coupled to the bottom edges of the front panel 20 and the back panel 22. The bottom panel may have a variety of shapes configured to create an internal volume that is able to receive the lure 60. For example, the bottom panel may be circular, oval, elliptical, eye-shaped, etc. The pouch 12 has a size (e.g., width, length, interior volume, etc.) that is configured for use with a wide variety of fishing lures and hooks. The pouch 12 may be constructed in multiple sizes to accommodate a wider range of salt and fresh water lures.

The front panel 20 and the back panel 22 are formed from a material that is sufficiently thick to resist being punctured by the lure 60. According to an exemplary embodiment, the front panel 20 and the back panel 22 are both formed from a transparent polymer material (e.g., polyvinyl chloride (PVC), polyethylene vinyl acetate (PEVA), polyolefin, etc.). Such a transparent polymer material may be waterproof, and may be formed to provide a relatively smooth surface, reducing the likelihood that hooks or other sharp or protruding portions of the lure 60 will catch on the surface of the front panel 20 or the back panel 22. Further, a transparent polymer material allows a user visually determine the identification of the lure 60 contained within the lure protector 10 without needing to remove the lure 60 from the pouch 12. In other embodiments, the front panel 20 or the back panel 22 may be formed from another flexible material, such as a woven or non-woven textile material. Such a textile material may be treated (e.g., coated) or otherwise processed such that the pouch 12 is substantially waterproof. In other embodiments, the ouch may be formed from a material that is partially or completely opaque. In still other embodiments, the pouch 12 may be a rigid or partially rigid container.

According to an exemplary embodiment, the front panel 20 and the back panel 22 are joined together with sewn seams. In other embodiments, the front panel 20 and the back panel 22 may be otherwise joined together, such as by welding (e.g., sonic welding), adhesives, or mechanical fasteners (e.g., staples, rivets, etc.).

A top opening 30 allows the fishing lure 60 to pass through the opening 30 and into the interior 28. The top opening 30 may be formed to be normally closed or partially closed, thereby retaining the lure 60 within the pouch 12. A insert may be provided at the top opening 30 to act as a stiffening member to shape the top opening 30 and facilitate the opening of the top opening 30 and reinforce the pouch 12 proximate to the top opening 30. According to an exemplary embodiment, the insert includes a pair of fins 32 that are disposed at the top of each of the front panel 20 and the back panel 22, proximate to the top opening 30.

The fins 32 and the top opening are configured such that a user may insert the lure 60 into the pouch 12 and withdraw the lure 60 from the pouch one-handed, without having to directly touch the lure 60. A user may open the pouch 12 by squeezing inward and placing pressure on the side edges of the pouch 12 at the fins 32, causing the fins 32 to deflect outward. This squeezing action results in an enlarging of the top opening 30, thereby allowing a lure 60 to pass through the top opening 30. To close the pouch 12, a user simply releases the pressure on the side edges of the pouch 12. The elasticity of the fins 32 causes them to return to their normal shape, thereby closing the top opening 30.

In one embodiment, the fins 32 may be formed from a polymeric material with a modulus of elasticity that allows it to be elastically deformed by the user squeezing inward on the side edges of the pouch 12. In other embodiments, the insert include devices such as spring hinges that are coupled to the pouch 12.

Each of the fins 32 have distal ends 33 that curve inward slightly such that, in a closed position, the top opening 30 remains slightly opened. The curved fins assure that a pressure applied to the side edges 24 of the pouch 12 will force the central portions of the fins will move outward, away from each other, thereby enlarging the top opening 30. Further, the slight opening between the fins 32 allows for continued airflow through the interior 28 of the pouch 12. This arrangement may help to inhibit the formation of mold, mildew, or other undesirable growth in the pouch 12.

According to an exemplary embodiment, the top portions of the front panel 20 and the back panel 22 are folded over and the edges secured (e.g., by sonic welding) to form a sleeve in which the fin 32 is held. In other embodiments, the fin 32 may be fastened to the outer surface or the inner surface of the front panel 20 or the back panel 22, such as with an adhesive. In still other embodiments, the fin 32 may be imbedded in the front panel 20 or the back panel 22 (e.g., trapped between multiple layers of the panel). In yet other embodiments, the fin 32 may not be a separate item than the front panel 20 or the back panel 22. For example, the front panel 20 or the back panel may include an integrally formed feature (e.g., a locally thickened portion) that performs the same function as the fin 32.

The pouch 12 may further include a bottom opening 34 that is located at or near the bottom edge of the pouch 12. The bottom opening 34 allows any water or other fluids to drain from the interior 28 of the pouch 12. In one embodiment, the bottom opening 34 is a gap between the front panel 20 and the back panel 22 along the bottom edge. The front panel 20 and the back panel 22 are tapered such that the bottom opening 34 is smaller than the top opening 30 and the lure 60 cannot pass through the bottom opening 34. In other embodiments, the bottom opening may be a slit, hole, or other opening formed in the front panel 20 and/or the back panel 22. In still other embodiments, the pouch 12 may be formed with a bottom panel that is coupled to the bottom edges of the front panel 20 and the back panel 22 and the bottom opening may be formed in the bottom panel.

The reinforcing spine 14 is coupled to the pouch 12. The reinforcing spine 14 has a greater strength and rigidity as compared to the pouch, which is generally more pliable. The reinforcing spine 14 may be formed, for example, from a polymer (e.g., nylon, PVC, polypropylene, etc.), a metal or metal alloy (e.g., aluminum, stainless steel, etc.), a composite material (e.g., a fiberglass-reinforced polymer), or a combination thereof.

The reinforcing spine 14 provides a structure to which a fishing line 62, and therefore the fishing lure 60 may be anchored. Further, the spine 14 may include a feature for attaching to the fishing pole 64. A force applied to the fishing line 62 may be translated through the reinforcing spine 14 to the fishing pole 64, bypassing the pouch 12 and reducing the likelihood of the pouch 12 being torn. According to an exemplary embodiment, the reinforcing spine 14 extends the entire length of the pouch 12 (e.g., from the top edge of the pouch 12 to the bottom edge of the pouch 12). In other embodiments, the reinforcing spine 14 may extend only a portion of the length of the pouch 12.

According to an exemplary embodiment, the reinforcing spine 14 is an elongated, substantially flat member that is disposed in a sleeve 36 on the back panel 22 of the pouch 12. The sleeve 36, in one embodiment, is formed by a panel coupled to the back panel 22, such as with sewn seams, sonic welding adhesives, etc. The sleeve 36 may be open on one or both ends. The reinforcing spine 14 is removably coupled to the pouch 12 and includes a first engagement feature, shown as a first catch 40, and a second engagement feature, shown as a second catch 42. The end of the reinforcing spine 14 including the first catch 40 is inserted into the sleeve 36 and is advanced into the sleeve 36 fully such that the first catch 40 engages the bottom edge of the sleeve 36. The second catch 42 engages the top edge of the sleeve 36. The pouch 12 is therefore fixed to the reinforcing spine 14 in a direction along the longitudinal axis of the reinforcing spine 14.

The reinforcing spine 14 may further include a member that is configured to engage the fishing pole 64. According to an exemplary embodiment, a hook 44 is coupled to the reinforcing spine 14 via a self-tapping threaded connection. The hook 44 is configured to engage a hook or eyelet 66 provided on the fishing pole 64. In other embodiments, the hook 44 may be otherwise coupled to the reinforcing spine 14, such as with an adhesive, or may be integrally formed with the reinforcing spine 14. In other embodiments, the reinforcing spine 14 may include another type of member configured to engage a corresponding member on the fishing pole 64. For example, the reinforcing spine 14 may include an eyelet or may form an opening configured to engage a hook provided on the fishing pole 64.

The fishing line 62 can be coupled to the reinforcing spine 14. After the lure 60 has been inserted into the pouch 12, the fishing line 62 attached to the lure 60 may be looped around the second catch 42 one or more times. With the fishing line 62 looped around the second catch 42, the end of the lure 60 to which the fishing line 62 is coupled is substantially fixed relative to the second catch 42 and the lure 60 is substantially secured within the pouch 12. The reinforcing spine 14 may then be coupled to the fishing pole 64, such as by inserting the hook 44 into the eyelet 66 on the fishing pole 64. With the fishing line 62 wrapped around the second catch 42 and the hook 44 inserted into the eyelet 66, a tensile force applied to the fishing line 62 is transferred through the reinforcing spine 14 to the fishing pole 64 without placing stress on the pouch 12 or the fishing lure 60. The material forming the pouch 12 may therefore be chosen from a greater range of materials because it need not be designed to withstand the stresses placed on the lure protector 10.

In other embodiments, the reinforcing spine 14 may comprise a wire formed from a metal or metal alloy. In other embodiments, the lure protector 10 may not include the reinforcing spine 14, but may instead include another reinforcing member. For example, the lure protector 10 may include a more complex framework having multiple members arranged both longitudinally and laterally relative to the pouch, a wire, or may include a solid plate to reinforce the pouch 12. In one exemplary embodiment, the back panel 22 of the pouch 12 may be a plate or other structural member that is able to perform the functions of the reinforcing spine 14 as described above.

The clip 16 is coupled to the pouch 12 and is configured to couple the lure protector 10 to the fishing pole 64. According to an exemplary embodiment, the clip 16 is removably coupled to the pouch 12. The lure protector 10 may therefore be provided as a kit with several clips 16 of various sizes and the user may choose the clip 16 that fits the fishing pole 64 being used. The clip 16 is a snap clip that is configured to engage the fishing pole 64 when it is pressed against it.

Referring to FIGS. 2 and 4, the clip 16 includes a base portion 50, a clip portion 52, and an arm portion 54 that engages the pouch 12. The clip 16 is formed from a resilient material such that it may flex to engage the fishing pole 64 with a snap fit. Preferably, the clip 16 is formed from a material with a hardness that will not mar the fishing pole 64 when the clip 16 engages the fishing pole 64. According to an exemplary embodiment, the clip 16 is formed from a polymer (e.g., nylon, polypropylene, etc.).

To couple the clip 16 to the pouch 12, the arm portion 54 is inserted into a first opening 55 in the back panel 22 of the pouch 12. When the clip 16 is fully inserted into the first opening 55 a lip 56 at the distal end of the arm portion 54 is received in a second opening 57 to secure the clip 16 to the pouch 12. The clip 16 may be removed from the pouch 12 (e.g., to replace the clip 16 with a clip of another size) by pushing down on the lip 56 to disengage the lip 56 from the second opening 57 and withdrawing the arm portion 54 from the first opening 55.

Referring to FIG. 4, the back panel 22 is shown to be multilayered. The back panel 22 includes an inner layer 25 and an outer layer 27. The first opening 55 and the second opening 57 are formed only in the outer layer 27 of the back panel 22 and the arm portion 54 is inserted into the space between the layers 25 and 27. The inner layer 25 provides a substantially smooth interior surface that is free from protruding elements that could be caught by hooks or other sharp or protruding portions of the lure 60 as it is inserted into or withdrawn out of the pouch 12. In some embodiments, only a portion of the back panel 22 may be multilayered (e.g., a portion of the back panel proximate to the openings 55 and 57). In some embodiments, the front panel 20 may also be multilayered.

In one embodiment, the clip portion 52 is oriented sideways, and the clip 16 is secured to the fishing pole 64 by pushing the clip 16 against the fishing pole 64 in sideways direction. In other embodiments, the clip 16 may be configured differently, such as with the clip portion oriented backwards such that the clip 16 is secured to the fishing pole 64 by pushing the clip 16 backwards against the fishing pole 64.

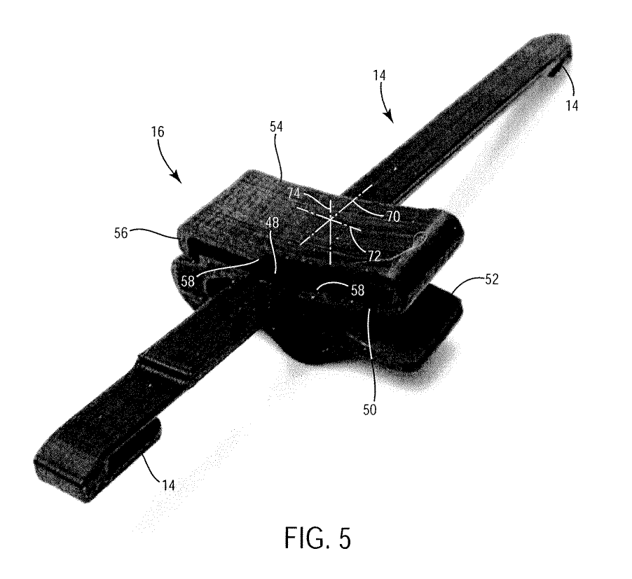

Referring now to FIG. 5, the reinforcing spine 14 and the clip 16 are shown with the pouch 12 hidden for clarity. The reinforcing spine 14 includes a recess 48 to accommodate the clip 16 and the clip 16 includes recesses 58 in the base portion 50 and/or the arm portion 54 to accommodate the reinforcing spine 14. With the reinforcing spine 14 coupled to the pouch 12 (e.g., inserted into the sleeve 36) and the clip 16 coupled to the pouch 12 (e.g., inserted into the first opening 55), the reinforcing spine 14 is disposed between the base portion 50 and the arm portion 54 of the clip 16. The reinforcing spine 14 and the clip 16 interlock to limit the relative movement of the reinforcing spine 14 and the clip 16 along a y axis 70 (e.g., in a direction parallel to a longitudinal axis of the reinforcing spine 14) and along an x-axis 72. The relative movement of the reinforcing spine 14 and the clip 16 is limited by the pouch 12 in a direction along a z axis 74.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the lure protector as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. Some like components have been described in the present disclosure using the same reference numerals in different figures. This should not be construed as an implication that these components are identical in all embodiments; various modifications may be made in various different embodiments. It should be noted that the elements and/or assemblies of the enclosure may be constructed from any of a wide variety of materials that provide sufficient strength or durability, in any of a wide variety of colors, textures, and combinations.

What is claimed is:

1. A lure protector, the lure protector comprising:
a pouch defining:
a top opening through which a fishing lure may pass, and
an interior sized to receive the fishing lure;
a reinforcing member coupled to the pouch, the reinforcing member including an end portion to which a fishing line may be coupled; and
a clip coupled to the pouch, the clip configured to couple the lure protector to a fishing pole.

2. The lure protector of claim 1, wherein the reinforcing member comprises a substantially rigid spine extending along the pouch from the top opening.

3. The lure protector of claim 1, further comprising a hook extending from the reinforcing member opposite of the end portion, the hook positioned as to engage a portion of the fishing pole.

4. The lure protector of claim 1, wherein the pouch comprises a flexible material.

5. The lure protector of claim 4, wherein the pouch comprises a transparent polymer.

6. The lure protector of claim 1, wherein the pouch comprises an inner layer and an outer layer, the inner layer providing a substantially surface defining the interior.

7. The lure protector of claim 1, further comprising a stiffening member coupled to the pouch proximate to the top opening.

8. The lure protector of claim 7, wherein the stiffening member comprises a pair of flexible concave fins.

9. The lure protector of claim 1, wherein the reinforcing member comprises a recessed portion, the recessed portion sized to receive a portion of the clip such that the clip is substantially fixed relative to the rib in a direction parallel to a longitudinal axis of the reinforcing member.

10. The lure protector of claim 1, wherein the clip is removably coupled to the pouch.

11. The lure protector of claim 1, wherein the pouch comprises a bottom opening, the bottom opening being smaller than the top opening.

12. A lure protector kit, comprising:
a lure protector, comprising:
a pouch, comprising:
a top opening through which a fishing lure may pass; and
an interior sized to receive the fishing lure; and
a reinforcing member coupled to the pouch, the reinforcing member comprising an end portion to which a fishing line may be coupled; and
a clip coupled to the pouch, the clip being configured to couple the lure protector to a fishing pole.

13. The lure protector kit of claim 12, wherein the reinforcing member comprises a substantially rigid spine extending along the pouch from the top opening.

14. The lure protector kit of claim 12, further comprising a hook extending from the reinforcing member opposite of the end portion, the hook positioned as to engage a portion of the fishing pole.

15. The lure protector kit of claim 12, wherein the pouch comprises a flexible transparent polymer.

16. The lure protector kit of claim 12, wherein the pouch comprises an inner layer and an outer layer, the inner layer providing a substantially smooth interior.

17. The lure protector kit of claim 12, further comprising a pair of flexible concave fins coupled to the top end of the pouch.

18. The lure protector kit of claim 12, wherein the reinforcing member comprises a recessed portion, the recessed portion sized to receive a portion of the clip such that the clip is substantially fixed relative to the rib in a direction parallel to a longitudinal axis of the reinforcing member.

19. The lure protector kit of claim 12, wherein the clip is removably coupled to the pouch.

20. The lure protector kit of claim 12, comprising a plurality of clips, the plurality of clips being sized to couple the lure protector to fishing poles of a plurality of diameters.

21. The lure protector kit of claim 12, wherein the pouch comprises a bottom opening, the bottom opening being smaller than the top opening.

22. A lure protector for a fishing lure attached to a fishing pole with a fishing line, comprising:
a pouch defining:
a top opening through which the fishing lure may pass; and
a substantially smooth interior sized to receive the fishing lure;
a stiffening member coupled to the pouch proximate to the top opening;
a reinforcing spine coupled to the pouch and extending along the pouch from the top opening, the reinforcing spine comprising a catch to which the fishing line may be coupled;
a hook extending from the reinforcing spine opposite of the catch; and
a clip coupled to the pouch, the clip configured to couple the lure protector to the fishing pole.

23. The lure protector of claim 22, wherein the pouch comprises an inner layer and an outer layer, the inner layer providing the substantially smooth interior;
And wherein the inner layer and the outer layer comprise a transparent flexible polymer.

24. The lure protector of claim 22, wherein the stiffening member comprises a pair of flexible concave fins.

25. A fishing pole system, comprising:
a fishing pole;
a fishing lure operatively connected to the fishing pole;
a fishing line operatively connected to the fishing lure and the fishing pole; and
a lure protector, comprising:
a pouch, defining:
a top opening through which the fishing lure may be pass; and
an interior sized to receive the fishing lure; and
a reinforcing member coupled to the pouch, the reinforcing member comprising an end portion to which the fishing line may be coupled; and
a clip coupled to the pouch, the clip removably coupling the lure protector to the fishing pole.

26. The fishing pole system of claim 25, wherein the reinforcing member comprises a substantially rigid spine extending along the pouch from the top opening.

27. The fishing pole system of claim 25, further comprising a hook extending from the reinforcing member opposite of the end portion, the hook positioned as to engage a portion of the fishing pole.

28. The fishing pole system of claim 25, wherein the pouch comprises a flexible material.

29. The fishing pole system of claim 25, wherein the pouch comprises a flexible transparent polymer.

30. The fishing pole system of claim 25, wherein the pouch comprises an inner layer and an outer layer, the inner layer providing a substantially smooth interior.

31. The fishing pole system of claim 25, further comprising a stiffening member coupled to the pouch proximate to the top opening.

32. The fishing pole system of claim 31, wherein the stiffening member comprises a pair of flexible concave fins.

33. The fishing pole system of claim 25, wherein the reinforcing member comprises a recessed portion, the recessed portion sized to receive a portion of the clip such that the clip is substantially fixed relative to the rib in a direction parallel to a longitudinal axis of the reinforcing member.

34. The fishing pole system of claim 25, wherein the clip is removably coupled to the pouch.

35. The fishing pole system of claim 25, wherein the pouch comprises a bottom opening, the bottom opening being smaller than the top opening
